(19) United States
(12) Patent Application Publication
(10) Pub. No.: US 2003/0167745 A1
(43) Pub. Date: Sep. 11, 2003

(54) Lawn striping assembly

(76) Inventor: Robert Greenhoe, DeWitt, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/385,093

(22) Filed: Mar. 10, 2003

Related U.S. Application Data
(60) Provisional application No. 60/363,120, filed on Mar. 11, 2002.

(51) Int. Cl. A01D 34/03

(52) U.S. Cl. 56/16.7

(57) ABSTRACT

The lawn striping assembly 10 includes a channel mechanism 14 having a plurality of attachment points 22, a pair of brackets 46, a roller apparatus 16 disposed on the channel mechanism 14 via a pair of fasteners 42. The roller apparatus 16 includes a plurality of rollers 74, an axle 76, and a pair of axle supports 78. The roller apparatus 16 is attached to the channel mechanism 14 via the pair of axle supports 78. Each bracket 46 is fixedly attached to a first pair of attachment points 48 and pivotally mounted on a lawn care device 12 via a rotatable fastener 62.

### CROSS-REFERENCE TO RELATED APPLICATIONS

This application claims the benefit of U.S. Provisional Patent Application Serial No. 60/363,120, filed Mar. 11, 2002.

### FIELD OF THE INVENTION

The subject invention generally relates to lawn care equipment and, more particularly, to lawn care equipment for bending grass.

### BACKGROUND OF THE INVENTION

In the area of lawn and playing field maintenance, grass striping is a common practice, generally used in combination with cutting grass, whereby the grass on a lawn or field is bent in a particular direction causing light to be reflected therefrom in order to achieve an aesthetically pleasing appearance.

Typically, grass striping is accomplished through the use of rollers. Such rollers are fixedly attached on a commercial lawn mower having front and rear tires and a mower deck having a mower blade rotatably disposed therein. Conventionally, the rollers are disposed rearward of the mower deck and forward of the rear tires such that, after the grass is cut by the blade, the remaining grass is immediately bent in a particular direction. After the blade cuts the grass, the roller bends the grass in the same direction that the roller is moving. With each pass along the lawn or field, the roller stripes the grass in a band having a width equal to that of the roller. Generally, both commercial and residential mowers lack the space required to include a roller between the mower deck and the rear tires.

Various commercial and residential mowers incorporate a turning feature or a zero-turning radius, whereby, upon turning, the inner tire on the inside of the turn radius rotates backward while the outer tire on the outside of the turning radius rotates forward. Upon turning, the roller fixedly disposed between the mower deck and the rear tires is forced to travel in a direction perpendicular to its axis of rotation. As a result, the roller becomes wedged in the grass, thereby inhibiting the mower from preventing the turn.

In addition, such rollers are typically mounted to the mower in a static position above the ground in order to provide ground clearance and accommodate the contours of the lawn or field being mowed. Consequently, the rollers do not sit directly on the grass and the resultant bend imparted thereto is minimized.

Moreover, conventional rollers are made from one-piece steel rollers which are specially manufactured to the size requirements of the particular mower, thereby increasing the time and cost for manufacturing and repair which is passed on to consumers.

### SUMMARY OF THE INVENTION AND ADVANTAGES

The subject invention is a lawn striping assembly for bending grass. The assembly includes a roller apparatus and a channel mechanism extending along a first axis and including a top portion having a plurality of attachment points. The assembly is rotatably mounted on a lawn care device.

Each part required to manufacture the assembly of the subject invention may be purchased off the shelf and in bulk, thereby reducing the time and costs for manufacture and repair, i.e., the invention relates to a new combination.

The assembly of the present invention is disposed rearward on the lawn care device. On a zero-turn radius lawn care device, the assembly may be disposed rearward of device or between the rear drive tires parallel with the wheel axis. Thus, the pivot point of the assembly mirrors the pivot point of the device. The assembly pivots with the drive tires which prevents the assembly from swinging perpendicular to the direction of the drive tires and scalping the grass. Further, the assembly is pivotally mounted to either the frame of the device or the mower deck. When pivotally mounted to the mower deck, a free-floating mower deck continues to float which also prevents scalping of the grass.

The assembly is pivotally mounted to the frame or the mower deck and, thus, the assembly of the subject invention rides on the ground at all times independently of the height of the mower deck or frame. As a result, a maximum bend is imparted to the grass which enhances the colors of the patterns created. Moreover, the mower deck may be adjusted without adjusting the height of the assembly therewith.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of the lawn striping assembly of the present invention disposed on a lawn care device;

FIG. 2 is a perspective view of the lawn striping assembly of the present invention;

FIG. 3 is an exploded perspective view of the lawn striping assembly of the present invention;

FIG. 4 is a bottom view of the lawn striping assembly of the present invention disposed on a zero turn-radius riding mower; and

FIG. 5 is a bottom view of the lawn striping assembly of the present invention disposed on a zero turn-radius walk-behind mower.

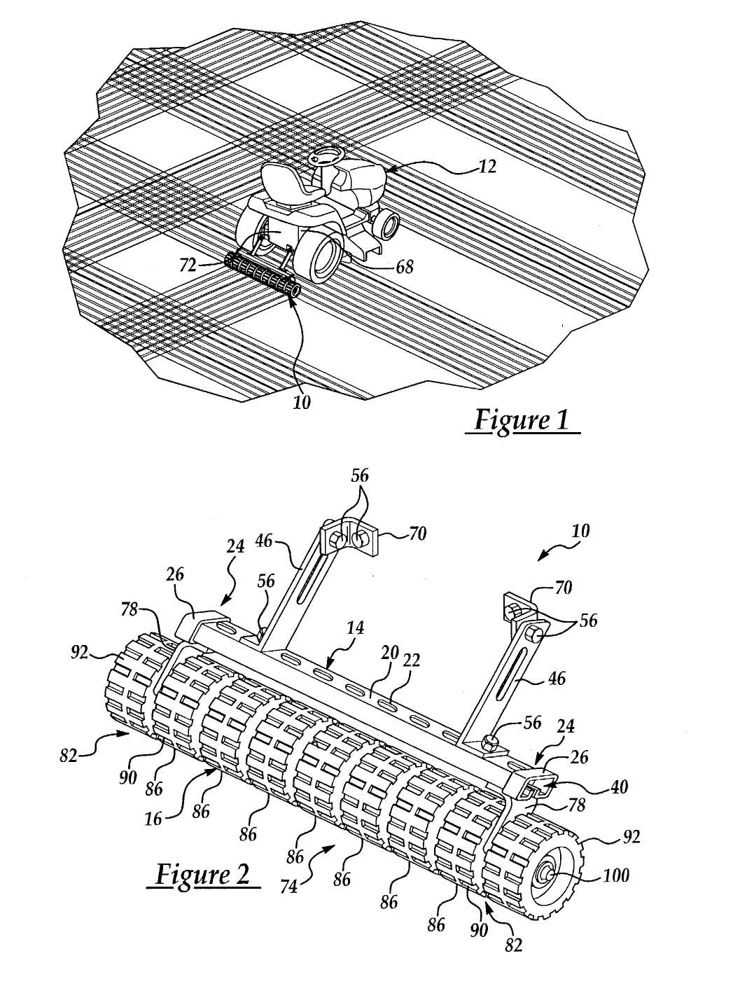

### DETAILED DESCRIPTION OF THE PREFERRED EMBODIMENT

Referring to the Figures, wherein like numerals indicate like or corresponding parts throughout the several views, a lawn striping assembly for bending grass is generally shown at 10. The lawn striping assembly 10 is disposed on a lawn care device, generally indicated at 12.

The lawn striping assembly 10 includes a channel mechanism, generally shown at 14, and a roller apparatus, generally shown at 16. The channel mechanism 14 extends along a first axis 18 and includes a top portion 20 having a plurality of attachment points 22. The channel mechanism 14 has opposing ends, generally indicated at 24, and an end cap 26 disposed on each of the opposing ends 24.

A first side wall 28 extends from the top portion 20 and defines a first shoulder 30 having a first lip 32. A second side wall 34 extends from the top portion 20 and defines a second shoulder 36 having a second lip 38. The top portion 20 and first and second side walls 28, 34 define a channel passageway, generally indicated at 40. A pair of fasteners 42 are slideably disposed on the channel mechanism 14 in the channel passageway 40 wherein each fastener 42 includes a pair of grooves 44 corresponding to each of the first 32 and second lips 38.

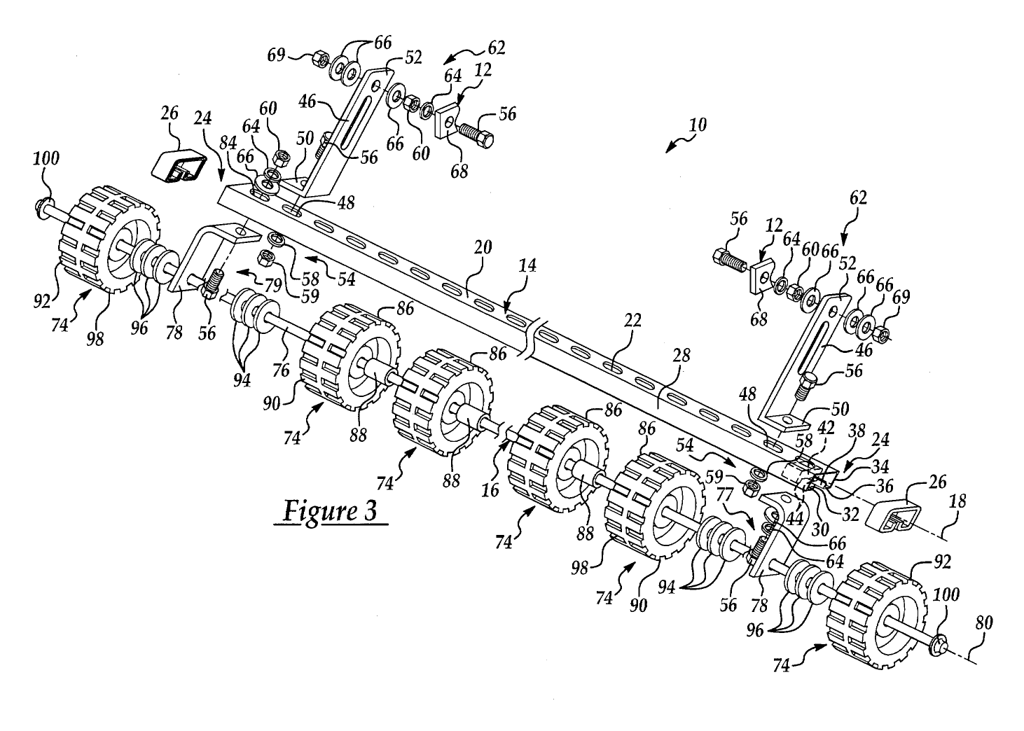

The assembly 10 of the present invention further includes a pair of brackets 46 for attaching to a first pair of attachment points 48. Each bracket 46 includes a first end 50 and a second end 52 wherein the first end 50 is fixedly attached to the first pair of attachment points 48 on the channel mechanism 14 via a first connector, generally shown at 54, as shown in FIG. 3. In the preferred embodiment, the first connector 54 includes a bolt 56, a washer 58, such as a split lock washer or any other suitable washer, and an oversized nut 59. The oversized nut 59 is a nut that, when tightened to the bolt, is disposed between the side walls 28, 34 which prevent the nut 59 from turning and backing off of the bolt 56. However, any suitable connector may be used to fixedly attach each of the brackets 46 to the channel mechanism 14.

The second end 52 of each bracket 46 is pivotally mounted on the lawn care device 12 via a rotatable fastener, generally shown at 62. In the preferred embodiment, the rotatable fastener 62 includes the bolt 56, a split lock washer 64, a nut 60, a jam nut 69, and a plurality of flat washers 66. Although any suitable rotatable fastener may be used to pivotally mount the second end 52 of each bracket 46 to the lawn care device 12. In one embodiment, the pair of brackets 46 are pivotally mounted on a pair of side edges 68 of the lawn care device 12.

In an alternate embodiment, an adapter 70, such as an L-shaped bracket, may be pivotally attached to the second end 52 of each bracket 46 via the rotatable fastener 62. The adapter 70 is also fixedly attached to a front edge 72 of the lawn care device 12.

The roller apparatus 16 includes a plurality of rollers, generally indicated at 74, that are identical, an axle 76, and a pair of axle supports 78 disposed on the axle 76. The axle 76 extends along a second axis 80 that is parallel to the first axis 18 of the channel mechanism 14. The plurality of rollers 74 are disposed on the axle 76 in axial alignment.

The axle supports 78 are disposed on the axle 76 and juxtaposed between a pair of rollers, generally indicated at 82. The roller apparatus 16 is attached to the channel mechanism 14 via the pair of axle supports 78. In one embodiment, the pair of axle supports 78 are each attached via a second connector 77 to the pair of fasteners 42 slidably disposed in the channel mechanism 14. The second connector 77 includes the bolt 56, the lock washer 64, and the flat washer 66. In this embodiment, the axle supports 78 are adjustable along the axle 76 by merely sliding the fasteners 42 through the channel passageway 40, and, thus, may be easily moved to any desired location along the channel mechanism 14 by changing the number of rollers 74 disposed on the axle 76 as required by a particular application.

In an alternate embodiment, the pair of axle supports 78 disposed on the axle 76 are each fixedly attached via a support connector 79 to a second pair of attachment points 84 disposed on the channel mechanism 14. The support connector 79 includes a bolt 56, the lock washer 64, the flat washer 66 and the nut 60. In this embodiment, any adjustment of the axle supports 78 requires the connectors 54 to be loosened, the axle support 78 relocated along the axle 76, and the connector 54 tightened once again.

In applications where increased support is necessary, additional axle supports 78 may be disposed on the axle 76 and attached to a corresponding additional fastener 42 slidably disposed in the channel mechanism 14. Alternatively, the additional axle support 78 may be attached directly to an additional one of the attachment points 22.

The width of the roller assembly 16 varies according to the lawn care device 12 for which it is designed. As shown in the Figures, one or more inner rollers 86 are axially aligned side-by-side on the axle 76 between the axle supports 78. A separator 88 is located between each inner roller 86 to reduce friction and lessen the wear and tear on the inner rollers 86.

The pair of axle supports 78 are located on the axle 76 outwardly of the outermost pair 90 of inner rollers 86. One or more outer rollers 92 are located outwardly from the axle supports 78. A first spacer 94 is disposed between each axle support 78 and the corresponding outermost inner roller 90. The first spacer 94 may include a plurality of washers or any other suitable spacer. A second spacer 96 is disposed between each of the axle supports 78 and the innermost outer roller 98. The second spacer 96 may include a plurality of washers or any other suitable spacer. The first and second spacers 94, 96 reduce friction and lessen wear and tear on the axle supports 78 and rollers 90, 98. A pair of axle caps 100 are mounted on opposing ends of the axle 76 to retain the rollers 74, axle supports 78, washers 94, 96, and separators 88 on the axle 76.

The lawn striping assembly 10 of the subject invention is mounted to the lawn care device 12. More particularly, the lawn care device 12 includes a frame 102 and a mower deck 104 having a mower blade 106 disposed therein, such as a walk-behind lawn care device, a riding lawn care device, a zero turn-radius lawn care device or any other suitable lawn care device.

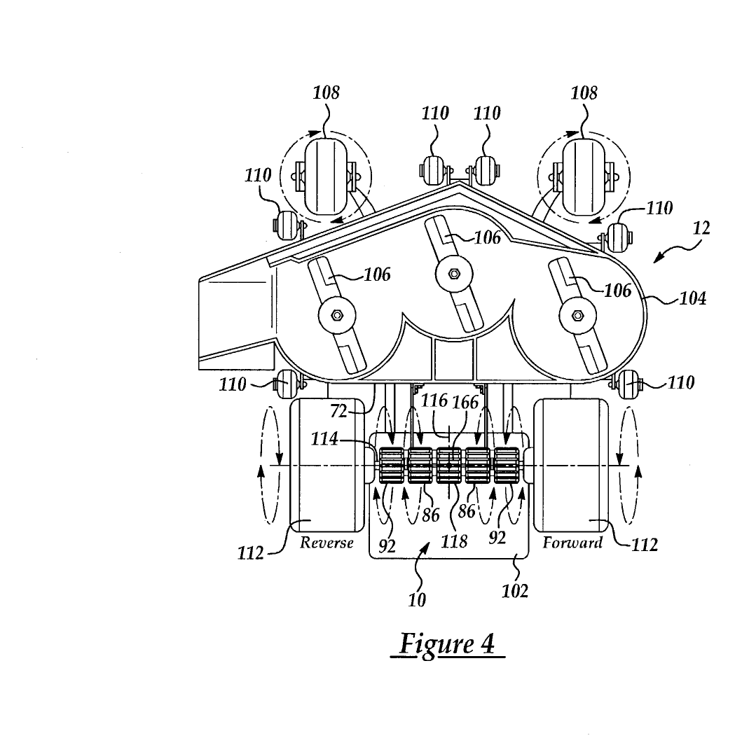

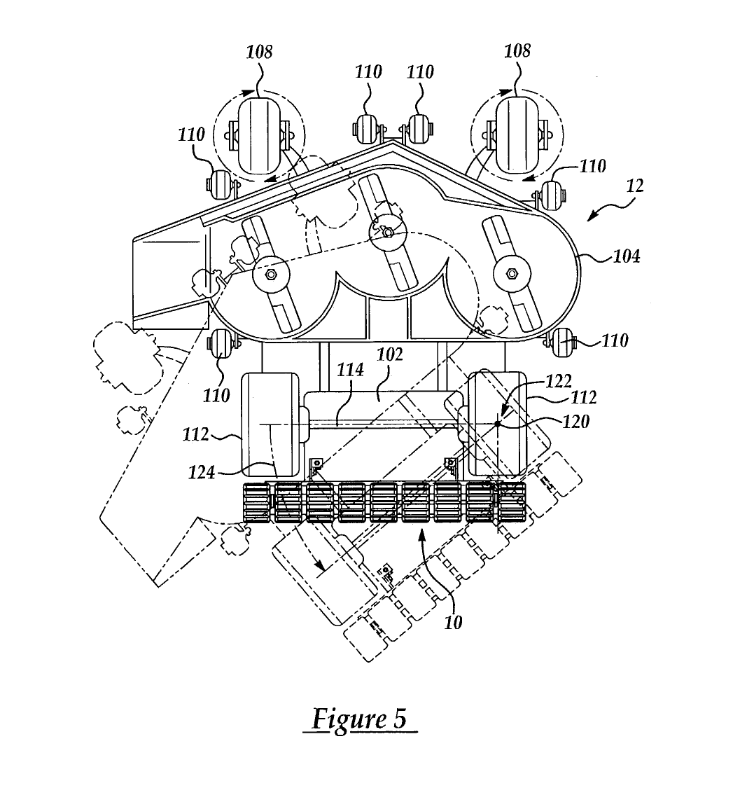

Referring to FIGS. 4 and 5, a zero turn-radius (“ZTR”) lawn care device 12 includes a pair of front drive tires 108 disposed on the frame 102, a plurality of mower deck wheels 110 attached to the mower deck 104, and a pair of rear drive tires 112 interconnected via a wheel axle 114. The ZTR riding lawn care device 12 is capable of pivoting about a first central turn axis 116.

Referring to FIG. 4, the first central turn axis 116 of a ZTR riding lawn care device 12 is located at or near the center point between the pair of rear drive tires 112. The ZTR riding lawn care device 12 pivots about the first central turn axis 116 by turning one rear drive tire 112 in the forward direction and turning the other rear drive tire 112 in the reverse direction.

The lawn striping assembly 10 of the subject invention is disposed between the rear drive tires 112 and parallel with the wheel axle 114 of the ZTR riding lawn care device 12. In operation, as the rear drive tires 112 of ZTR riding lawn care device 12 roll about the first central turn axis 116, the lawn striping assembly 10 pivots in conjunction therewith. More specifically, the outer 92 and inner rollers 86 closest to the forward moving rear drive tire 112 roll forward. The outer 92 and inner rollers 86 closest to the rearward moving rear drive tire 112 roll rearward. The center roller 118 at the center of the axle 76 and in alignment with the first central turn axis 116 does not roll or rolls only slightly because it has the same central turn axis as the ZTR riding lawn care device 12 and serves as the pivot point for the lawn striping assembly 10.

Referring to FIG. 5, a second central turn axis 120 of a ZTR walk-behind lawn care device 12 is located at or near a center point, generally shown at 122, of one of the rear drive tires 112 and, more particularly, the rear drive tire 112 which is located on the inside of the turn. More specifically, the ZTR walk-behind lawn care device 12 pivots about the second central turn axis 120 when the brake is applied to one of the rear drive tires 112. The rear drive tire 112 to which the brake is applied locks in place and becomes the pivot point on the inside of the turn.

The lawn striping assembly 10 of the subject invention is disposed behind the rear drive tires 112 and parallel with the wheel axle 114. In operation, as the outside rear drive tire 112 pivots around the second central turn axis 120 of the static rear drive tire 112 and forms an arc 124 thereabout, the lawn striping assembly 10 pivots accordingly. More specifically, the outer rollers 92 of the lawn striping assembly 10 which are positioned behind the static rear drive tire 112 are also static or roll only slightly and serve as the pivot point of the assembly 10. The outer rollers 92 positioned behind the outside rear drive tire 112 and the inner rollers 86 roll about the static rollers 92 and follow the arc 124 about the lawn striping assembly 10 pivot point.

The invention has been described in an illustrative manner, and it is to be understood that the terminology that has been used is intended to be in the nature of words of description rather than limitation. It is recognized that those skilled in the art may make various modifications or additions to the preferred embodiments chosen herein to illustrate the present invention, without departing from the spirit of the present invention. Accordingly, it is to be understood that the subject matter sought to be afforded protection should be deemed to extend to the subject matter defined in the appended claims, including all equivalents thereof

What is claimed is:

1. A lawn striping assembly 10 for bending grass, comprising:
a roller apparatus 16; and
a channel mechanism 14 extending along a first axis 18 and including a top portion 20 having a plurality of attachment points 22.

2. An assembly 10 as set forth in claim 1 including a pair of brackets 46 for attaching to a first pair 48 of said plurality of attachment points 22.

3. An assembly 10 as set forth in claim 2 wherein said roller apparatus 16 includes a plurality of rollers 74.

4. An assembly 10 as set forth in claim 3 wherein each of the plurality of rollers 74 is identical.

5. An assembly 10 as set forth in claim 4 wherein said roller apparatus 16 includes an axle 76 extending along a second axis 80 and having said plurality of rollers 74 disposed on said axle 76.

6. An assembly 10 as set forth in claim 5 wherein said channel mechanism 14 includes a first side wall 28 extending from said top portion 20 and defining a first shoulder 30 having a first lip 32 and a second side wall 34 extending from said top portion 20 and defining a second shoulder 36 having a second lip 38.

7. An assembly 10 as set forth in claim 6 including a pair of fasteners 42 slideably disposed on said channel mechanism 14 between said first 28 and second side walls 34 wherein each fastener 42 includes a pair of grooves 44 corresponding to said first 32 and second 38 lips.

8. An assembly 10 as set forth in claim 7 including a pair of axle supports 78 disposed on said axle 76 and attached to said pair of fasteners 42.

9. An assembly 10 as set forth in claim 5 including a pair of axle supports 78 disposed on said axle 76 and attached to a second pair 84 of said plurality of attachment points 22.

10. A lawn striping assembly 10 disposed on a lawn care device 12, said assembly 10 comprising:
a roller apparatus 16; and
a channel mechanism 14 extending along a first axis 18 and including a top portion 20 having a plurality of attachment points 22.

11. An assembly 10 as set forth in claim 10 including a pair of brackets 46 for attaching to a first pair 48 of said plurality of attachment points 22.

12. An assembly 10 as set forth in claim II wherein said roller apparatus 16 includes a plurality of rollers 74.

13. An assembly 10 as set forth in claim 12 wherein each of the plurality of rollers 74 is identical.

14. An assembly 10 as set forth in claim 13 wherein said roller apparatus 16 includes an axle 76 extending along a second axis 80 and having said plurality of rollers 74 disposed on said axle 76.

15. An assembly 10 as set forth in claim 14 wherein said channel mechanism 14 includes a first side wall 28 extending from said top portion 20 and defining a first shoulder 30 having a first lip 32 and a second side wall 34 extending from said top portion 20 and defining a second shoulder 36 having a second lip 38.

16. An assembly 10 as set forth in claim 15 including a pair of fasteners 42 slideably disposed on said channel mechanism 14 between said first 28 and second side walls 34 wherein each fastener 42 includes a pair of grooves 44 corresponding to said first 32 and second lips 38.

17. An assembly 10 as set forth in claim 16 including a pair of axle supports 78 disposed on said axle 76 and attached to said pair of fasteners 42.

18. An assembly 10 as set forth in claim 17 wherein each bracket 46 includes a first end 50 and a second end 52, wherein said first end 50 is fixedly attached to said channel mechanism 14 and said second end 52 is pivotally mounted on the lawn care device 12.

19. An assembly 10 as set forth in claim 18 wherein the lawn care device 12 includes a frame 102 and a mower deck 104.

20. An assembly 10 as set forth in claim 19 wherein said assembly 10 is pivotally mounted on said mower deck 104 via said pair of brackets 46.

21. An assembly 10 as set forth in claim 20 wherein said lawn care device 12 is a zero-turn radius riding lawn care device having a pair of rear drive tires 112.

22. An assembly 10 as set forth in claim 21 wherein said assembly 10 is disposed between said pair of rear drive tires 112.

23. An assembly 10 as set forth in claim 19 wherein said assembly 10 is pivotally mounted on said frame 102 via said pair of brackets 46.

24. An assembly 10 as set forth in claim 23 wherein said lawn care device 12 is a zero-turn radius lawn care device.

25. An assembly 10 as set forth in claim 23 wherein said lawn care device 12 is a walk-behind lawn care device.

26. An assembly 10 as set forth in claim 23 wherein said lawn care device 12 is a riding lawn care device.

27. An assembly 10 as set forth in claim 14 including a pair of axle supports 78 disposed on said axle 76 and attached to a second pair 84 of said plurality of attachment points 22.
